(19) United States
(12) Patent Application Publication
(10) Pub. No.: US 2005/0257724 A1
(43) Pub. Date: Nov. 24, 2005

(54) Additive-induced control of NOx emissions in a coal burning utility furnace

(76) Inventors: Gregory H. Guinther, Richmond, VA (US); Michael Wayne Adams, Richmond, VA (US)

Correspondence Address: DENNIS H. RAINEAR, CHIEF PATENT COUNSEL, ETHYL CORPORATION, 330 SOUTH FOURTH STREET, RICHMOND, VA, 23219, US

(21) Appl. No.: 10/852,497

(22) Filed: May 24, 2004

(51) Int. Cl. F23C 1/10; C01B 21/00

(52) U.S. Cl. 110/345; 423/235

(57) ABSTRACT

NOₓ emissions may be lowered from the combustion of coal in a furnace. The method includes providing a furnace having a combustion chamber in which is combusted coal and oxygen. Further, coal and a metal containing combustion catalyst are delivered into the combustion chamber together with a reduced amount of oxygen as compared the amount of oxygen combusted in the combustion chamber without the metal-containing combustion catalyst. The thermal efficiency and combustion stability of the furnace are not decreased as a result of the reduction combustion air and provision of metal containing additives to the combustion chamber.

This invention relates to a method and a combustion composition that lower NOx emissions in a coal burning utility furnace. Specifically, the use of a metal-containing combustion catalyst and a simultaneous reduction in combustion oxygen lowers NOx emissions without sacrificing combustion stability and thermal efficiency of the coal burning furnace.

### BACKGROUND

Utility furnaces employ excess amounts of combustion oxygen (combustion air) over and above the required stoichiometric levels in order to achieve more stable combustion and to optimize the thermal efficiency of the furnace. The downside is that excess combustion air promotes the rate of NOx formation, hence increasing NOx emissions. For coal burning furnaces, the amount of excess air can range between about 3 to 15 percent by volume above stoichiometric. This is often recorded as “excess oxygen” in which case the range is about 0.8 to 4 percent excess oxygen.

Since NOx formation is known to be proportional to the amount of oxygen present, increasing levels of combustion oxygen result in increased levels of NOx emissions. Conversely, by reducing combustion oxygen, the level of NOx emission can be reduced. Unfortunately, high levels of excess oxygen facilitate a more stable combustion and a higher thermal efficiency of the furnace in converting fuel to energy. Therefore, reduced NOx inherently results in reduced stability of combustion and a relatively lower thermal efficiency of the furnace.

### SUMMARY

Accordingly, it is an object of the present invention to simultaneously overcome the foregoing problems and drawbacks with reducing NOx emissions. Specifically, the use of a metal-containing combustion catalyst in combination with reduced amounts of combustion oxygen can lower NOx emissions without sacrificing the combustion stability and thermal efficiency of a furnace.

In one example, a method lowers NOx emissions resulting from the combustion of coal in a furnace, the method comprising the steps of providing a furnace having a combustion chamber in which is combusted coal and oxygen, delivering into the combustion chamber a metal-containing combustion catalyst, providing a reduced amount of oxygen to the combustion chamber as compared with the amount of oxygen combusted in the combustion chamber without the metal-containing combustion catalyst, wherein the thermal efficiency and/or combustion stability of the furnace is not decreased as compared with the thermal efficiency and/or combustion stability of the furnace without the delivery of the combustion catalyst and reduced amount of oxygen in the combustion chamber.

### BRIEF DESCRIPTION OF THE DRAWINGS

FIG. 1 is a plot of the excess oxygen sweep (x axis) versus NOx and furnace thermal efficiency (y axis). The data plotted on the figure is taken from Table 1.

FIG. 2 is a list of coals and their respective properties that are used in an exemplary power plant.

### DETAILED DESCRIPTION

The present invention is directed to lowering NOx emissions resulting from the combustion of coal in a utility furnace without reducing the combustion stability and thermal efficiency of the furnace. This reduction in NOx emissions is obtained by delivering a metal-containing catalyst into the combustion chamber in combination with lowering the amount of combustion oxygen provided to the combustion chamber.

As used herein, the term “NOₓ” is used to refer to the chemical species nitric oxide (NO) and nitrogen dioxide (NO₂). Other oxides of nitrogen are known, such as N₂O, N₂O₃, N₂O₄ and N₂O₅, but these species are not emitted in significant quantities from stationary combustion sources (except N₂O in some systems).

It is a particular feature of the present invention that the methods described herein can be carried out using a wide variety of conventional combustion devices. Thus, any combustion device that includes a combustion zone for oxidizing a combustible coal fuel can be used. For example, the combustion zone may be provided in a power plant, boiler, furnace, magnetohydrodynamic (MHD) combustor, incinerator, engine, or other combustion device. In one example, the combustion device includes low-NOₓ burners.

Thus, in one embodiment is provided herein a method of lowering NOx emissions resulting from the combustion of coal in a furnace, the method comprising the steps of: providing a furnace having a combustion chamber in which is combusted coal and oxygen, delivering into the combustion chamber coal and a metal-containing combustion catalyst, providing a reduced amount of oxygen to the combustion chamber as compared with the amount of oxygen combusted in the combustion chamber without the metal-containing combustion catalyst, wherein the thermal efficiency of the furnace is not decreased as compared with the thermal efficiency of the furnace without the delivery of the combustion catalyst and reduced amount of oxygen in the combustion chamber.

In another embodiment herein is provided a method of lowering NOx emissions resulting from the combustion of coal in a furnace, the method comprising the steps of: providing a furnace having a combustion chamber in which is combusted coal and oxygen, delivering into the combustion chamber coal and a metal-containing combustion catalyst, providing a reduced amount of oxygen to the combustion chamber as compared with the amount of oxygen combusted in the combustion chamber without the metal-containing combustion catalyst, wherein the combustion stability of the furnace is not decreased as compared with the combustion stability of the furnace without the delivery of the combustion catalyst and reduced amount of oxygen in the combustion chamber.

The term “thermal efficiency” refers to the ability of the system to create power from the combustion of the coal. The specific calculation of thermal efficiency is the ratio of power (kilowatts) produced per 1000 BTUs of energy combusted.

The term “combustion stability” is defined herein by transient oscillations in key combustion parameters while all combustion settings are mechanically fixed on a combustion apparatus. For example, when the O₂, CO, NOₓ, CO₂ meters used to set and monitor the combustion process start to oscillate randomly about the set points, then that is a sign that combustion instability has set in. Combustion instability can be triggered in a furnace by a gradual perturbation of the air-to-fuel ratio, through either a gradual cutback or increase in excess combustion air, until the meters described above start to oscillate randomly. The consequences of combustion instability are an increase in environmental pollutant emissions and drop in efficiency of the furnace.

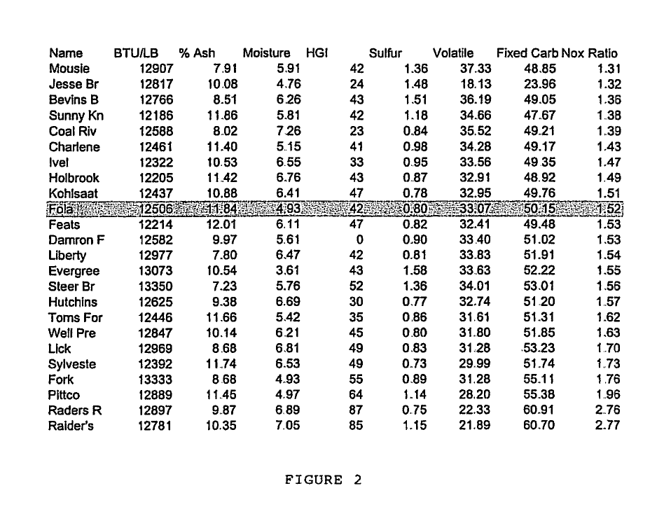

Attached as FIG. 2 is a table of different coals that have been burned at a single utility site. The Fola coal noted in FIG. 2 is the coal that was used for purposes of an example described herein. Coals having relatively high NOₓ ratios are especially able to benefit from use of the method described herein. In one example, coal having a NOₓ ratio greater than about 1.20, or alternatively greater than about 1.50, can be combusted and achieved the benefits described herein.

The metal-containing combustion catalyst may include one or more of the following metals: manganese, potassium, calcium, strontium, chromium, iron, cobalt, copper, lanthanide, cerium, platinum, palladium, rhodium, ruthenium, iridium and osmium. The amount of metal-containing combustion catalyst useful in achieving the benefits disclosed herein may vary depending on the particular metal or metals, the type of metal-containing catalyst, the particular type of coal, the particular type of coal-burning furnace, and other processing conditions. The catalyst can be mixed with the coal and/or combustion oxygen before and/or in the combustion chamber.

In order to enhance the effectiveness of the metal as a catalyst to the combustion reaction, the metal-containing compound that is mixed with the coal should make the metal available in a mononuclear or small cluster fashion. In this way, more metal is dispersed on the coal (carbon) particles during combustion.

It is hypothesized that the significant level of metal, including manganese, that is naturally occurring in coal does not have an appreciable affect in improving combustion, because, for instance, the manganese is bound together in crystalline forms such as with sulfur or phosphorous. Therefore, there is not a significant amount of mononuclear or small cluster metal atoms available to surround and catalyze the combustion of coal (carbon) particles. The effect on combustion of naturally occurring metals therefore, appears to be negligible.

The term “mononuclear” compound includes one where a metal atom is bound in a compound which is essentially soluble. An example is an organometallic manganese compound that is soluble in various organic solvents. Compounds that have “small clusters” of metal atoms include those with 2 to about 50 atoms of manganese. In this alternative, the metal atoms are still sufficiently dispersed or dispersible to be an effective catalyst for the combustion reaction. When discussing solubility in terms of mononuclear and small cluster atoms, the term solubility means both fully dissolved in the traditional sense, but also partially dissolved or suspended in a liquid medium. As long as the metal atoms are adequately dispersed in terms of single atoms or up to about 50 atom clusters, the metal atoms are sufficient to provide a positive catalytic effect for the combustion reaction.

Examples of mononuclear compounds include organometallic compounds. Useful as organo-groups of organometallic compounds effective in achieving the benefits disclosed herein, in one example, include alcohols, aldehydes, ketones, esters, anhydrides, sulfonates, phosphonates, chelates, phenates, crown ethers, naphthenates, carboxylic acids, amides, acetyl acetonates, and mixtures thereof. Manganese containing organometallic compounds include manganese tricarbonyl compounds. Such compounds are taught, for example, in U.S. Pat. Nos. 4,568,357; 4,674,447; 5,113,803; 5,599,357; 5,944,858 and European Patent No. 466 512 B1.

Suitable manganese tricarbonyl compounds which can be used to achieve the benefit disclosed herein include cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tert-butylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, indenyl manganese tricarbonyl, and the like, including mixtures of two or more such compounds.

One example is the cyclopentadienyl manganese tricarbonyls which are liquid at room temperature such as methylcyclopentadienyl manganese tricarbonyl, ethylcyclopentadienyl manganese tricarbonyl, liquid mixtures of cyclopentadienyl manganese tricarbonyl and methylcyclopentadienyl manganese tricarbonyl, mixtures of methylcyclopentadienyl manganese tricarbonyl and ethylcyclopentadienyl manganese tricarbonyl, etc.

Preparation of such compounds is described in the literature, for example, U.S. Pat. No. 2,818,417, the disclosure of which is incorporated herein in its entirety.

Treat rates in one example range from 2-50 ppm metal relative to the amount of coal for metal sources with between 1-3 metal atoms per molecule of metal-containing combustion catalyst dissolved either in an aqueous or hydrocarbon medium to give a homogeneous solution. For colloidal solutions, i.e. high metal content carboxylates, sulfonates, phosphonates, phenates, etc, with particle sizes below 5 nanometers (nanoparticles), the treat range may be extended to 80 ppm metal relative to the amount of coal. For metal particle dispersions in organic or aqueous solvents, with a metal particle size distribution between 5-300 nanometer diameter, the treat rate range may be widened to 400 ppm metal relative to the amount of coal. This is because catalytic activity is highly dependent on catalyst dispersion and hence how much metal of the combustion catalyst is exposed to the fuel during the combustion reaction.

The more dispersed the metal atoms are, the less catalyst is necessary to achieve the same turnover rate.

### EXAMPLE

The data in Table 1 was obtained from a commercial utility furnace unit used to make steam for generating electricity. The unit is a Wall-Fired Babcock and Wilcox Boiler that operates on coal. The coal burned was Fola coal, see FIG. 2.

The furnace is equipped with 12 low-NOx burners, but is not capable of operating overfire air. The peak power output is 80-MW. The NOx %, Efficiency %, and Load %, data in Table 1 are normalized with regard to “Base” values obtained without additive, and that is why they show a zero value in the row titled “Base”.

TABLE 1
Percent Changes in NOx, and Furnace Thermal Efficiency, with
MMT Applied to the Coal, as Excess Oxygen is Lowered

| | Actual | | | | Excess |
|---|---|---|---|---|---|
| | O2, % | NOₓ (%) | Efficiency (%) | Load (%) | Air (%) |
| Base | 3.07 | 0 | 0 | 0 | 11.54 |
| Additive | 2.84 | −3.1 | 0.43 | 1.05 | 10.68 |
| Additive | 2.53 | −6.3 | −0.27 | 0.79 | 9.51 |
| Additive | 2.42 | −9.4 | 2.17 | 0.66 | 9.1 |
| Additive | 2.21 | −10.9 | 1.87 | 0.79 | 8.31 |
| Additive | 2.21 | −9.4 | 1.94 | 0.52 | 8.31 |
| Additive | 2.05 | −12.5 | 1.71 | 0.66 | 7.71 |
| Additive | 2.16 | −12.5 | 1.23 | 0.66 | 8.12 |
| Additive | 2.36 | −12.5 | 1.95 | 0.66 | 8.87 |
| Additive | 2.4 | −10.9 | 1.56 | 0.79 | 9.02 |

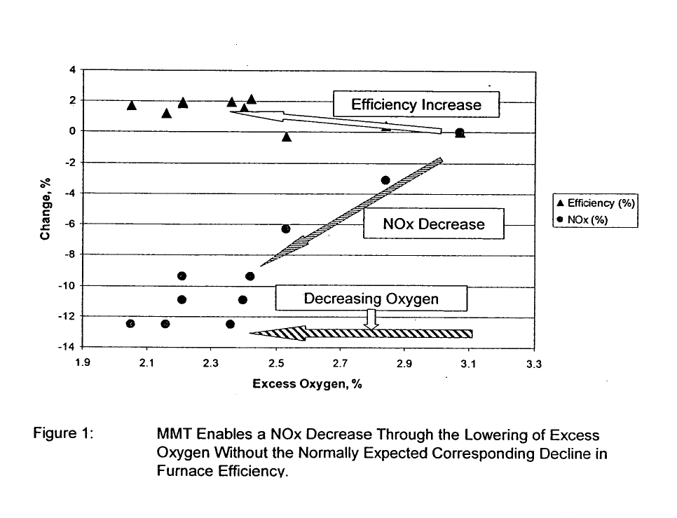

FIG. 1 is a plot of the excess oxygen sweep α-axis) versus NOx and Furnace Thermal Efficiency (y-axis). The data to the plot is selected from Table 1. Normally, a decrease in excess oxygen (a decrease in excess air) results in a decrease in NOx but at the expense of furnace thermal efficiency. FIG. 1 shows that the additive of this invention enables a NOx lowering by method of decreasing excess oxygen without a corresponding decrease in combustion stability and thermal efficiency. In fact, the amount of oxygen provided to the combustion chamber was reduced up to 50% of the amount of oxygen above stiochiometric. This is unexpected and economically beneficial.

It is to be understood that the reactants and components referred to by chemical name anywhere in the specification or claims hereof, whether referred to in the singular or plural, are identified as they exist prior to coming into contact with another substance referred to by chemical name or chemical type (e.g., base fuel, solvent, etc.). It matters not what chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together either in performing a desired chemical reaction (such as formation of the organometallic compound) or in forming a desired composition (such as an additive concentrate or additized fuel blend). It will also be recognized that the additive components can be added or blended into or with the base fuels individually per se and/or as components used in forming preformed additive combinations and/or sub-combinations. Accordingly, even though the claims hereinafter may refer to substances, components and/or ingredients in the present tense (“comprises”, “is”, etc.), the reference is to the substance, components or ingredient as it existed at the time just before it was first blended or mixed with one or more other substances, components and/or ingredients in accordance with the present disclosure. The fact that the substance, components or ingredient may have lost its original identity through a chemical reaction or transformation during the course of such blending or mixing operations or immediately thereafter is thus wholly immaterial for an accurate understanding and appreciation of this disclosure and the claims thereof.

At numerous places throughout this specification, reference has been made to a number of U.S. Patents, published foreign patent applications and published technical papers. All such cited documents are expressly incorporated in full into this disclosure as if fully set forth herein.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

Patentee does not intend to dedicate any disclosed embodiments to the public, and to the extent any disclosed modifications or alterations may not literally fall within the scope of the claims, they are considered to be part of the invention under the doctrine of equivalents.

1. A method of lowering NOx emissions resulting from the combustion of coal in a furnace, the method comprising the steps of:
providing a furnace having a combustion chamber in which is combusted coal and oxygen,
delivering into the combustion chamber coal and a metal-containing combustion catalyst,
providing a reduced amount of oxygen to the combustion chamber as compared with the amount of oxygen combusted in the combustion chamber without the metal-containing combustion catalyst,
wherein the thermal efficiency of the furnace is not decreased as compared with the thermal efficiency of the furnace without the delivery of the combustion catalyst and reduced amount of oxygen in the combustion chamber.

2. The method as described in claim 1, wherein the furnace comprises low-NOx burners.

3. The method as described in claim 1, wherein reduction in the amount of oxygen provided to the combustion chamber is a reduction of up to 50% of the amount of oxygen above stoichiometric.

4. The method as described in claim 1, wherein the metal-containing combustion catalyst comprises manganese.

5. The method as described in claim 4, wherein the metal-containing combustion catalyst comprises an organometallic compound.

6. The method as described in claim 5, wherein the metal-containing combustion catalyst comprises MMT.

7. The method as described in claim 1, wherein the metal-containing combustion catalyst comprises a metal selected from the group consisting of potassium, calcium, strontium, chromium, iron, cobalt, copper, lanthanide, cerium, platinum, palladium, rhodium, ruthenium, iridium and osmium.

8. The method as described in claim 1, wherein the metal-containing combustion catalyst is delivered at a rate of about 2 to about 400 ppm of metal in the catalyst relative to the amount of coal.

9. The method as described in claim 1, wherein the metal-containing combustion catalyst is delivered at a rate of about 2 to about 80 ppm of metal in the catalyst relative to the amount of coal.

10. The method as described in claim 1, wherein the metal-containing combustion catalyst is delivered at a rate of about 2 to about 50 ppm of metal in the catalyst relative to the amount of coal.

11. A method of lowering NOx emissions resulting from the combustion of coal in a furnace, the method comprising the steps of:
providing a furnace having a combustion chamber in which is combusted coal and oxygen,
delivering into the combustion chamber coal and a metal-containing combustion catalyst,
providing a reduced amount of oxygen to the combustion chamber as compared with the amount of oxygen combusted in the combustion chamber without the metal-containing combustion catalyst,
wherein the combustion stability of the furnace is not decreased as compared with the combustion stability of the furnace without the delivery of the combustion catalyst and reduced amount of oxygen in the combustion chamber.

12. The method as described in claim 11, wherein the furnace comprises low-NOx burners.

13. The method as described in claim 11, wherein reduction in the amount of oxygen provided to the combustion chamber is a reduction of up to 50% of the amount of oxygen above stoichiometric.

14. The method as described in claim 11, wherein the metal-containing combustion catalyst comprises manganese.

15. The method as described in claim 14, wherein the metal-containing combustion catalyst comprises an organometallic compound.

16. The method as described in claim 15, wherein the metal-containing combustion catalyst comprises MMT.

17. The method as described in claim 11, wherein the metal-containing combustion catalyst comprises a metal selected from the group consisting of potassium, calcium, strontium, chromium, iron, cobalt, copper, lanthanide, cerium, platinum, palladium, rhodium, ruthenium, iridium and osmium.

18. The method as described in claim 11, wherein the metal-containing combustion catalyst is delivered at a rate of about 2 to about 400 ppm of metal in the catalyst relative to the amount of coal.

19. The method as described in claim 11, wherein the metal-containing combustion catalyst is delivered at a rate of about 2 to about 80 ppm of metal in the catalyst relative to the amount of coal.

20. The method as described in claim 11, wherein the metal-containing combustion catalyst is delivered at a rate of about 2 to about 50 ppm of metal in the catalyst relative to the amount of coal.
